(19) United States
(12) Patent Application Publication
(10) Pub. No.: US 2017/0259980 A1
(43) Pub. Date: Sep. 14, 2017

(54) Condiment Packages

(71) Applicant: Alyse Nicole Merritt, Land O'Lakes, FL (US)

(72) Inventor: Alyse Nicole Merritt, Land O'Lakes, FL (US)

(21) Appl. No.: 15/067,153

(22) Filed: Mar. 10, 2016

(51) Int. Cl. B65D 75/58; A23L 27/00

(52) U.S. Cl. CPC B65D 75/5883; A23L 27/00; A23V 2002/00

(57) ABSTRACT

A condiment package is formed from two leaves of foil material. A spout is formed either from the underlying material of the foil or is made from another piece of material and attached to the portion of the foil materials. The package is a dual design such that two containers are attached along a separable barrier. Spouts are located between the two containers, at the ends thereof, diagonally, or at multiple spots thereon.

### CROSS REFERENCE TO RELATED APPLICATIONS

This application claims priority to U.S. Provisional Patent Application No. 62/131,766 filed on Mar. 11, 2015 and herein incorporation by reference in its entirety.

### FIELD OF THE INVENTION

The present invention relates to a condiment package device; more particularly, the invention relates to a condiment package device having novel ways to store, open and eject the contents therein contained.

### BACKGROUND OF THE INVENTION

Condiment packages currently in circulation have various features that render them unappealing for future use. In particular, the DIP and SQUEEZE is one such example that has a hard shell case causing a problem in that it is difficult to eject all of the contents therefrom because of that very same hard plastic. This invariably leaves a residue within the container that becomes unsanitary when a user attempts to extract the aforementioned with his or her fingers. Further, as some is left in the container, bacteria grows thereon in the dumpster causing further problems down the food cycle.

Another problem with the DIP and SQUEEZE is that the technology used in its manufacture is of a different sort then the traditional rectangular foil packages so familiar to most. Thus, a new factory had to be set up to accommodate the manufacture of this type of package that is more costly, time consuming and uses more complex plastics and processes to facilitate the production of the device.

Additionally, consumers have become accustomed to the much more simple rectangular packaging so prevalent in an enormous number of eateries world wide. Typically a top and bottom ‘foil’ leaf are attached together using heat treatment or adhesives along their periphery so as to create a chamber within the confines of the condiment package. An edge of the package has a rip-off portion where the user breaks it and later expels the contents as desired.

This simple package typically holds everything from ketchup to jellies in a simple, convenient package. However, this packaging also presents difficulties in that the user has to break the container which may lead to opening it too much causing an eruption of the contents thereon about the user.

Accordingly, there needs to be some solution to overcome the aforementioned problems. In particular, the solutions taught herein provide cost effective, easy ejection of internal materials from the device and ones that uses similar manufacturing technology as to the original foil rectangular package designs already in use globally.

### SUMMARY OF THE INVENTION

The present invention overcomes the deficiencies of the known art and the problems that remain unsolved by providing:

A condiment package comprising:
a first container constructed from
   a first leaf of material attached to
   a second leaf of material and
   a first spout affixed thereto.
      In another aspect, wherein the first spout further comprises:
an integrally shaped spout.
   In another aspect, wherein the first spout further comprises:
a spout formed from material distinct from the first and second leaf.
   In another aspect, further comprising:
a spout hiding portion.
   In another aspect, further comprising:
a weakly attached portion of the first and second leaves.
   In another aspect, further comprising:
a second container attached thereto having a second spout.
   In another aspect, further comprising:
a second container attached thereto having a spout portion integral with the first spout.
   In another aspect, further comprising:
a second container attached thereto having a second spout at a diagonally offset side from a first spout.
   In another aspect, further comprising:
a second container attached thereto having a second spout on the same side of the second container as a symmetric side of the first container has its first spout.
   In another aspect, further comprising:
a second container attached thereto having a third spout at a first end, a fourth spout at a second end whilst the first container has a second spout on an opposite side of the first container where the first spout resides.
   In another aspect, further comprising:
a second container having multiple spouts.
   In another aspect, further comprising:
a second spout attached to the first container.

A condiment device comprising:
a first leaf of material attached along its periphery to
a second leaf of material forming
a first container integrally attached to
a second container also formed from the first leaf of material and second leaf of material wherein the first container has a first spout and a second container has a second spout such that the first spout and second spout are directed towards each other along a border between the first and second containers.

A condiment device comprising:
a second leaf of material forming
a first container integrally attached to
a second container also formed from the first leaf of material and second leaf of material wherein the first container has a first spout and a second container has a second spout wherein the first and second containers are attached together longitudinally along a separable portion of the first and second leaves of material that have been attached together.
   In another aspect, wherein the first spout is on a first side of the first container and the second spout is on a similar side of the second container.
   In another aspect, wherein the first spout is on a first side of the first container and the second spout is on a opposed side of the second container.
   In another aspect, further comprising:
a third spout on the first container.
   In another aspect, further comprising:
a fourth spout on the second container.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1A presents a front view of a dual chamber condiment package in an embodiment taught herein.

FIG. 1B presents a side view of a dual chamber condiment package in an embodiment taught herein.

FIG. 2A presents a front view of a condiment package having a spout device in another embodiment taught herein.

FIG. 2B presents a closeup view of a right top portion of the condiment package of

FIG. 2A in an embodiment taught herein.

FIG. 2C presents a closeup view of a left top portion of the condiment package of

FIG. 2A in an embodiment taught herein.

FIG. 2D presents a closeup view of the right top portion of the condiment package of

FIG. 2A with the fold closed in an embodiment taught herein.

FIG. 3A presents a front view of a vertical dual chamber condiment package in another embodiment taught herein.

FIG. 3B presents a side view of a vertical dual chamber condiment package in an embodiment herein.

FIG. 4A presents a front view of a vertical dual chamber condiment package in an embodiment as taught herein having a central separation portion and diagonally opposite spouts.

FIG. 4B presents a front view of a vertical dual chamber condiment package in an embodiment as taught herein having a central separation portion and multiple spouts.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

For purposes of description herein, the terms “upper”, “lower”, “left”, “rear”, “right”, “front”, “vertical”, “horizontal”, and derivatives thereof shall relate to the invention as oriented in each figure. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

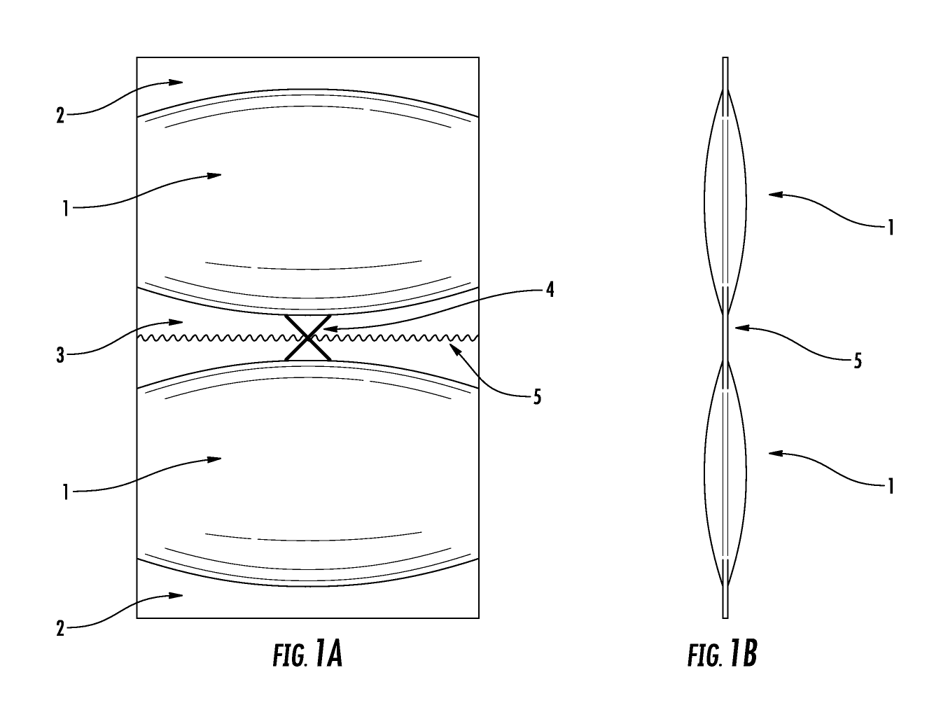

FIG. 1A presents a front view of a dual chamber condiment package in an embodiment taught herein. A rectangular top and bottom foil of packaging material are formed into a condiment package having an upper and a lower condiment containers 1; an adhesive or heat treatment seals the device along the external edges thereof completing its external rectangular shape. Additionally, seals are made at the periphery of condiment containers 2 such that there is a holding zone 2 at each end of the package and there is a space separating the two.

Between the two containers is a central tearing region 3 having a jagged indentations 5 making separation of the two containers 1 easier; these indentations are made by a machine that grasps the material of the foils and bites them in order to provide this feature.

Two triangle shaped spouts 4 are formed within the central tearing region 3 opposite one another; the large portion of the spouts 4 originate from either container 1 and the smaller portion forms the mouth of the spout ending at the apex of each oppositely formed triangle. This provides a place whereby user actuation of the tearing central region's 3 indentations 5 will open the spouts 4 permitting a user to eject the container 1 contents therefrom. It should be understood that the creation of the spouts is by proper heat treatment or adhesive application along a portion of the top and or bottom foils thereby providing this structure to the device.

Finally, two holding zones 2, one at either longitudinal end of the rectangle permit the user to grasp the device appropriately. It should be readily understood that the two foils, top and bottom, are heat treated, adhesively connected, glued or otherwise attached together appropriately along the periphery of the rectangle, the zones 2, and central tearing region 3 forming a completed package thereof

FIG. 1B presents a side view of a dual chamber condiment package in an embodiment of FIG. 1A taught therein.

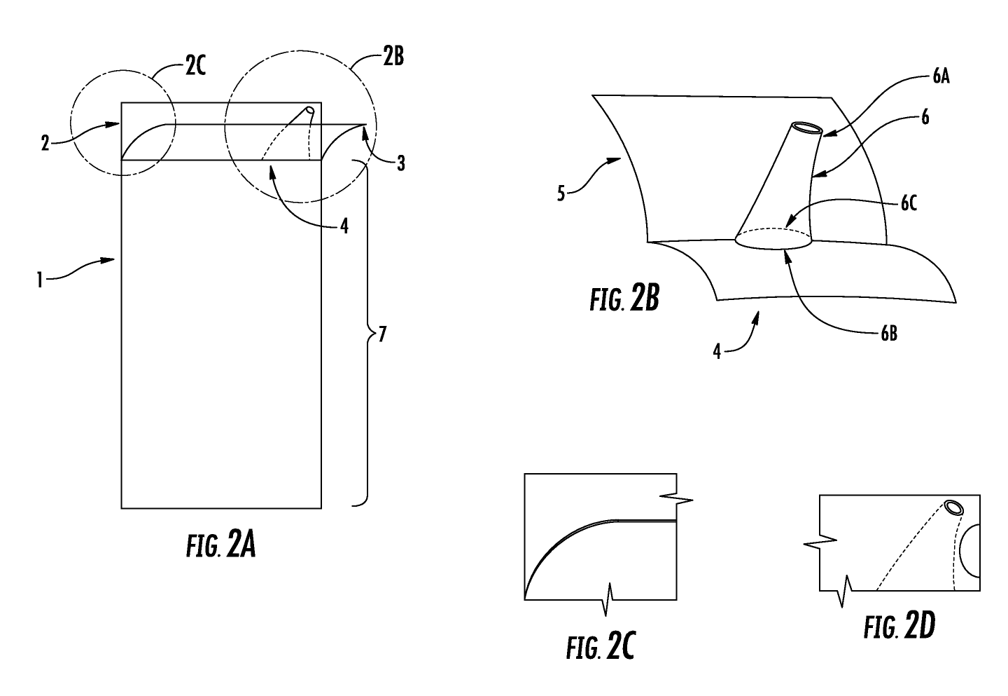

FIG. 2A presents a front view of a condiment package in an embodiment herein. A rectangular condiment package 1, formed from top and bottom foils, is permanently connected using heat treatment, strong adhesive and or glue along the periphery of the container portion 7; and at an edge that connects the removable rectangular portions 4, 5 to the container portion 7 thereby sealing the top side of the container portion 7. It is also connected with a weak adhesive, gel or rubbery substance (found in various packaging devices where removal of an item is desired with application of a small amount of physical force from the user; also found in mailers with attachments to a card or letter) along an opening zone, 3A formed by the body of the two portions 4, 5.

This opening zone 3A has a spout 6 that clears or is distinct from removable portions 4, 5 of the top and bottom foils; in other words, the spout 6 is connected to removable portions 4, 5 but is NOT formed structurally from the portions 4, 5. These rectangular removable portions 4, 5 of the top and bottom foils are used to cover the spout 6 when pressed together. This is accomplished using a weak adhesive, gel or rubbery substance that is strong enough to bring the removable portions 4, 5 together and cover the spout 6 and keep them closed during storage but weak enough for a user to remove with little effort.

FIG. 2B presents a closeup view of a right top portion of the condiment package in an embodiment taught herein. The spout 6 body is conical in shape having a narrow exit 6A and a larger entry formed by entry portions 6B, 6C that opens into the container portion 7. The entry portion 6B is integrally heat treated, adhesively attached to a removable portion 4 of the device whilst 6C is is integrally heat treated, adhesively attached to a removable portion 5 of the device. These two 6B, 6C together form an entry way for substances in the container 7 to be pushed there through and on and up the spout 6 and expelled through exit 6A.

FIG. 2C presents a closeup view of a left top portion of the condiment package of FIG. 2A in an embodiment herein.

FIG. 2D presents a closeup view of the right top portion of the condiment package of

FIG. 2A with the fold closed in an embodiment herein. This view shows a small portion that has been cut out if either the portion 4 or the portion 5 thereby providing a finger grip device for facilitating removable of one or the other portions 4, 5.

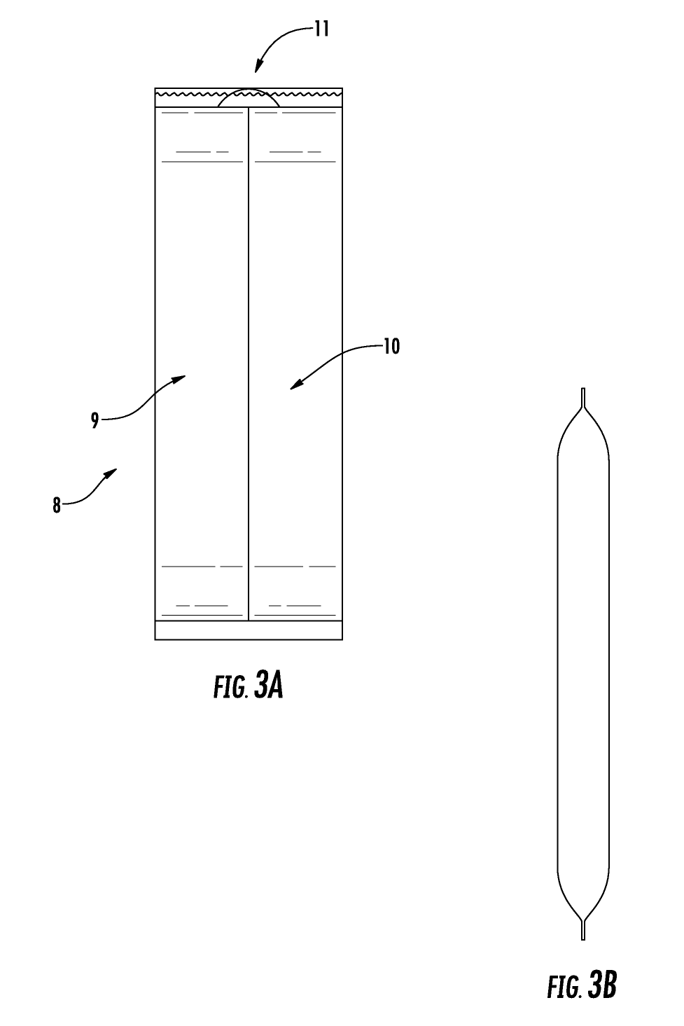

FIG. 3A presents a vertical dual chamber condiment package 6 in an embodiment taught herein. A top and bottom foil are glued together along its rectangular periphery including its top, bottom, right sides, left sides and down a center thereof forming a dual longitudinal container package; a small top and bottom holding region are also contemplated. Two containers 9, 10 having two identical or different condiments stored therein are thereby created. Ejecting the materials therein is accomplished through a spout 11 that sits about an entryway of both containers 9, 10. A user rips the top holding region thereby permitting ejection of the materials in the containers 9, 10. The spout is formed by appropriate heat treatment, glue, adhesive application in the shape of the spout desired by a user.

### Alternatives

It should be understood that if a user wishes to uses the extendable spout, removable portions found in the embodiment of FIG. 2A-2B in this embodiment of FIG. 3A then appropriate alterations to the structure would be required to ensure a smaller container 9, 10 to accommodate the removable portion atop the device and to permanently seal the edges between these two only along an edge thereof as it impacts the main containers' body.

Similarly, if a user wishes to use the ‘shaped spout’ of FIG. 3A whereby the material of the top and bottom foils is shaped into a spout in the embodiment of FIG. 2A then appropriate correction is necessary of the structure to accommodate the alteration along with permanently gluing of the top and bottom removable portions 4, 5 and opening up of the boundary between these and the container 7 in that embodiment of FIG. 2A.

### Further Embodiments

FIG. 3B presents a side view of a vertical dual chamber condiment package in an embodiment taught herein. It should be understood that the spouts taught in any embodiment are generally areas where the top and bottom foils are not glued internally to that shape just along the edges of that shape to form the spout unless a distinct spout as that found originally in FIG. 2A is specifically indicated.

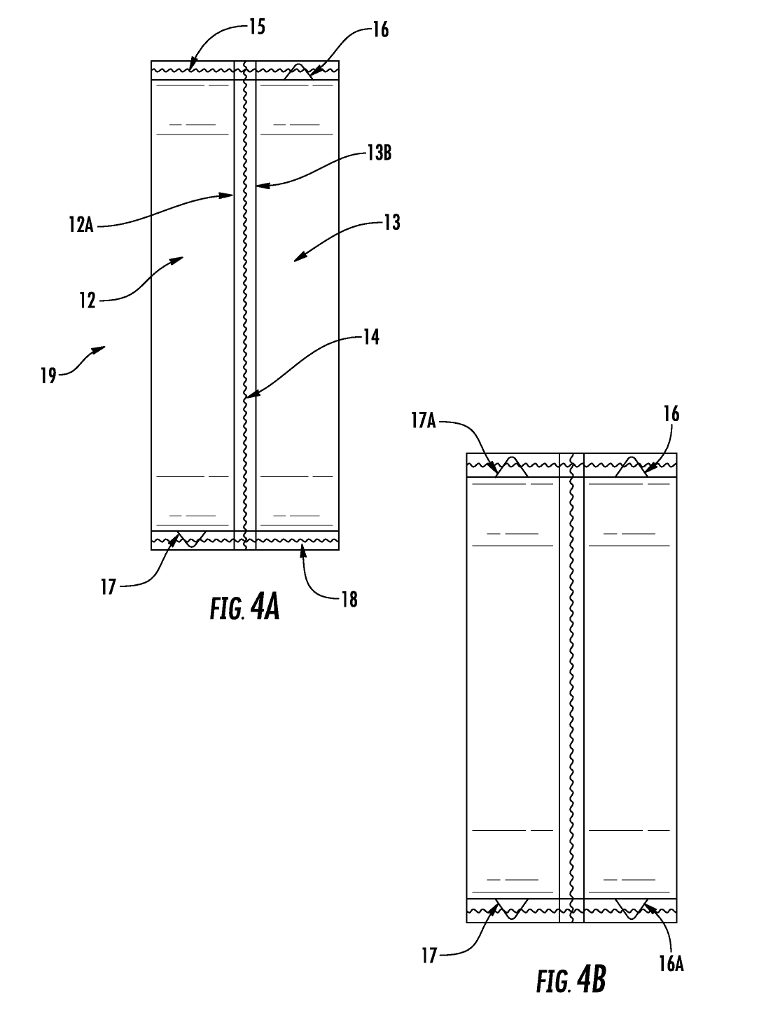

FIG. 4A presents a front view of a vertical dual chamber condiment package in an embodiment having a central separation portion and diagonally opposite spouts formed from two foil leaves. A rectangular condiment package 11 has two containers 12, 13 arranged longitudinally that have been permanently sealed along its periphery using heat treatment, glue, and or adhesives.

The border 12A of the container 12 and its opposite mirror border 13B associated with container 13 are also attached similarly along the two foil leaves forming the body of the package. A central longitudinal tearing portion 14 has a central jagged indentation for user separation of the two packages 12, 13.

An end region glued together in any embodiment having this region 15, 18 has a jagged indentation for ripping of the spouts 16, 17 respectively; these can be arranged at an angle to the spout if so desired with the spouts 16, 17 arranged closer to and or directed to the rectangular edge nearest them. The spouts are areas formed between the two foil leaves where the top and bottom foils are not glued internally to that shape just along the edges of that shape to form the spout.

FIG. 4B presents a front view of a vertical dual chamber condiment package in an embodiment having a central separation portion and multiple spouts. This version has two spouts for each container; container 12 has a top spout 17A and a bottom spout 17 whilst container 13 has a top spout 16 and bottom spout 16A.

### Final Considerations

There are two types of spouts presented herein: a first type of spout where the foil leaves comprising the body of a container ‘shape’ the spout by appropriate gluing, heat treatment and or adhesive application of the foil leaves; and a second type of spout where the spout is formed by other material and is attached along an end thereof to a portion of the foil leaves forming a pathway for expulsion of elements from the internals spaces of the container. Any of the embodiments herein taught are easily altered to permit either of these two alternatives. The spout can be located about the body of the container in any size, shape or manner that does not depart from the spirit and scope of the herein described embodiments.

The above-described embodiments are merely exemplary illustrations of implementations set forth for a clear understanding of the principles of the invention. Many variations, combinations, modifications or equivalents may be substituted for elements thereof without departing from the scope of the invention. Therefore, it is intended that the invention not be limited to the particular embodiments disclosed as the best mode contemplated for carrying out this invention, but that the invention will include all the embodiments falling within the scope of the appended claims.

What is claimed is:

1. A condiment package comprising:
a first container constructed from
a first leaf of material attached to
a second leaf of material and
a first spout affixed thereto.

2. The condiment package of claim 1, wherein the first spout further comprises:
an integrally shaped spout.

3. The condiment package of claim 1, wherein the first spout further comprises:
a spout formed from material distinct from the first and second leaf

4. The condiment package of claim 1, further comprising:
a spout hiding portion.

5. The condiment package of claim 1, further comprising:
a weakly attached portion of the first and second leaves.

6. The condiment package of claim 1, further comprising:
a second container attached thereto having a second spout.

7. The condiment package of claim 1, further comprising:
a second container attached thereto having a spout portion integral with the first spout.

8. The condiment package of claim 1, further comprising:
a second container attached thereto having a second spout at a diagonally offset side from a first spout.

9. The condiment package of claim 1, further comprising:
a second container attached thereto having a second spout on the same side of the second container as a symmetric side of the first container has its first spout.

10. The condiment package of claim 1, further comprising:
a second container attached thereto having a third spout at a first end, a fourth spout at a second end whilst the first container has a second spout on an opposite side of the first container where the first spout resides.

11. The condiment package of claim 1, further comprising:
a second container having multiple spouts.

12. The condiment package of claim 1, further comprising:
a second spout attached to the first container.

13. A condiment device comprising:
a first leaf of material attached along its periphery to
a second leaf of material forming
a first container integrally attached to
a second container also formed from the first leaf of material and second leaf of material wherein the first container has a first spout and a second container has a second spout such that the first spout and second spout are directed towards each other along a border between the first and second containers.

14. A condiment device comprising:
a second leaf of material forming
a first container integrally attached to
a second container also formed from the first leaf of material and second leaf of material wherein the first container has a first spout and a second container has a second spout wherein the first and second containers are attached together longitudinally along a separable portion of the first and second leaves of material that have been attached together.

15. The condiment device of claim 14, wherein the first spout is on a first side of the first container and the second spout is on a similar side of the second container.

16. The condiment device of claim 14, wherein the first spout is on a first side of the first container and the second spout is on a opposed side of the second container.

17. The condiment device of claim 14, further comprising:
a third spout on the first container.

18. The condiment device of claim 17, further comprising:
a fourth spout on the second container.
